(19) United States
(12) Patent Application Publication
(10) Pub. No.: US 2016/0188714 A1
(43) Pub. Date: Jun. 30, 2016

(54) TRACKING DEVICE FOR AUDIO PLAYBACK

(71) Applicant: AudioEye, Inc., Tucson, AZ (US)

(72) Inventors: Nathaniel T. Bradley, Tucson, AZ (US); Sean Bradley, Tucson, AZ (US); James Crawford, Fall City, WA (US)

(21) Appl. No.: 14/587,915

(22) Filed: Dec. 31, 2014

(51) Int. Cl. G06F 17/30

(52) U.S. Cl. CPC G06F 17/30752; G06F 17/30879

(57) ABSTRACT

A system, method, and device for communicating information. A designated signal is transmitted to a tracker from a device. A signal is received from the tracker. An identifier associated with the tracker is determined from the signal. Information associated with the identifier is retrieved. The information is communicated to the user at least audibly.

### BACKGROUND

The use of and development of tracking technologies has grown nearly exponentially in recent years. The growth is fueled by larger networks with more reliable protocols and better communications hardware available to manufacturers, service providers, and consumers. In many cases, tracking information associated with a device or item has been very limited. For example, a user might only be able to retrieve a product identification or universal product code (UPC) associated with a particular item.

### SUMMARY

One embodiment provides a system, method, non-transitory machine-readable storage medium, and device for communicating information. A designated signal may be transmitted to a tracker from a device. A signal may be received from the tracker. An identifier associated with the tracker may be determined from the signal. Information associated with the identifier may be retrieved. The information may be communicated to the user at least audibly.

Another embodiment provides an apparatus for communicating information audibly. The apparatus may include a scanner configured to transmit a designated signal to an audio tracker. The scanner may receive a signal from the audio tracker. The apparatus may also include a controller in communication with the scanner configured to determine an identifier associated with the audio tracker from the signal, retrieve information associated with the identifiers, and communicate the information at least audibly to a user utilizing the device.

Another embodiment provides a method for communicating medication related information. The method may include generating audio information for association with a tracker of an item. The method may further include determining an identifier associated with the tracker, associating the audio information with the identifier, storing the audio information on a non-transitory computer readable medium for subsequent retrieval utilizing the identifier, and determining occurrence of a medication event using a computing device configured to access the audio information. In response to determining the occurrence of the medication event by the computing device, the method may provide for playing the audio information.

### BRIEF DESCRIPTION OF THE DRAWINGS

The present embodiments may be better understood, and numerous objects, features, and advantages made apparent to those skilled in the art by referencing the accompanying drawings.

FIG. 1 is a pictorial representation of a tracking system in accordance with an illustrative embodiment;

FIG. 2 is a pictorial representation of a tracking network in accordance with an illustrative embodiment;

FIG. 3 is a block diagram of a device for performing audio playback in accordance with an illustrative embodiment;

FIG. 4 is flowchart of a process for associating information with an audio tracker in accordance with an illustrative embodiment;

FIG. 5 is a flowchart of a process for playing audio information associated with an audio tracker in accordance with an illustrative embodiment;

FIG. 6 is a block diagram of a device in accordance with an illustrative embodiment;

FIG. 7 is a pictorial representation of a computer system 700 in accordance with an illustrative embodiment.

FIG. 8 is a pictorial representation of an audio bottle holder in accordance with an illustrative embodiment.

### DESCRIPTION OF EMBODIMENT(S)

The illustrative embodiments provide systems, methods, devices, and computer program products for playing audio information to a user in response to retrieving an identifier associated with an item. The identifier may be stored in a tracking device or component, such as a machine-readable code (e.g., QR code, bar code, serial number), an ultra-small microtransponder tag (e.g., P-Chip®), radio frequency identification (RFID) tag, or other similar component. The tracking devices (or trackers) may be configured for one time usage or for repeated usage. The identifier may be retrieved from the tracking device in response to being scanned. In one embodiment, an optical signal may temporarily power the tracking device to communicate the identifier.

The identifier may be associated with audio information that may be played or otherwise communicated to the user. In one embodiment, the audio information may provide additional information associated with the item that has the tracking device. Examples of items may include medication, documents, antiques, and other valuable or important items.

In one embodiment, the audio information may provide instructions, background, commands, history, warnings, or other information that may be useful to a user or other third party. The audio information may be played directly by a device configured to activate the tracking device. In another embodiment, the audio information may be retrieved from a central location through one or more networks based on scanning or retrieving the identifier from the tracking device. For example, a smart phone may be utilized to activate a P-chip retrieving and identifier that is communicated through a cloud network to one or more network devices storing the audio information. The audio information is then communicated to and played through a speaker of the smart phone to the user.

In one embodiment, the audio information may be played to the user in stages. For example, the audio information may include conditional or nested communications that require a response from the user. The identifier and the audio information may be secured utilizing any number authentication systems. In one embodiment, the device or user may be required to provide a password or other authenticating information in order to access the audio information. In other embodiments, biometrics, such as fingerprint scans, retinal identifications, or other similar identifiers may be utilized. In another embodiment, the audio information may be communicated to any user or party that accesses the tracking device. Any or all parts of the retrieval process for the audio information may be authenticated utilizing passwords, encryption, biometrics, or other security systems or processes.

The tracking device may be connected, attached, manufactured, painted, integrated with, or otherwise attached to the item. In one embodiment, the tracking device may be covered with plastic, resin, glass, or other translucent, or semi-translucent materials, and still activated to communicate the identifier. The tracking device may be positioned in a known location, such as part of the items branding, or any default position to ensure that any number of users may be able to scan or illuminate the tracking device to determine the identifier.

Another embodiment provides an audio bottle holder that may interact with a medicine container to communicate relevant information to the user at least audibly. The audio bottle holder may scan or otherwise determine information associated with the audio and communicate the information to the user. The audio bottle holder may be utilized to communicate reminders, consumption instructions, ask about symptoms, or otherwise provide information to the user. An automatically generated voice may be utilized or audio from a doctor, pharmacist, family member, or friend may be utilized to provide an additional level of comfort. The information may also be communicated through a transceiver to a connected electronic device (e.g., cell phone, speaker, intercom system, tablet, computer, monitoring device, etc.). The information may also be communicated through a display (e.g., text, braille, etc.). As a result, the user may have additional guidance and support for the comfort of the user and other's concerned about the well-being of the user.

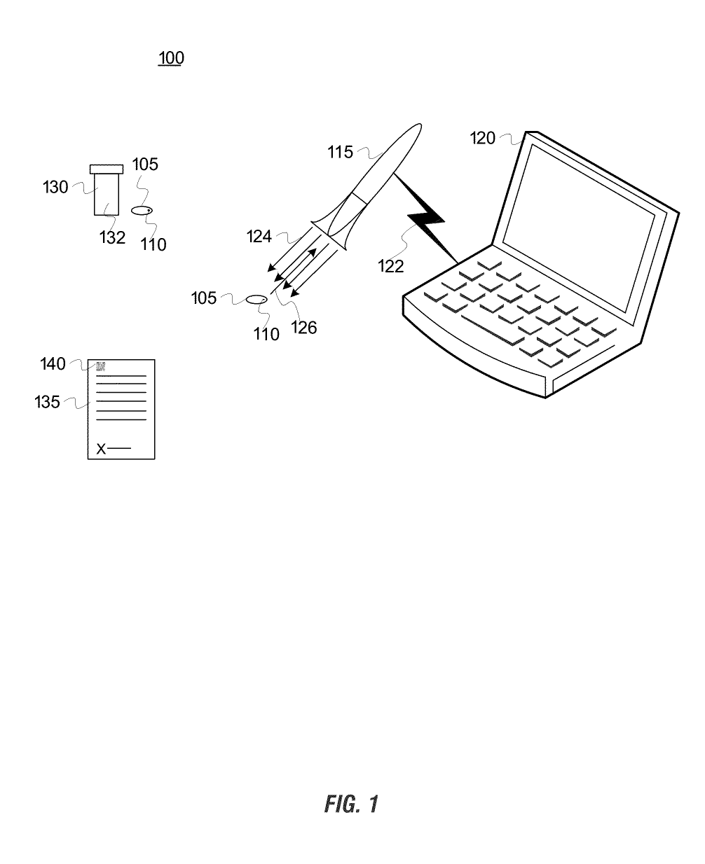

FIG. 1 is a pictorial representation of a tracking system 100 in accordance with an illustrative embodiment. The tracking system 100 may include any number of devices or components. The tracking system 100 is shown in one configuration for illustration purposes only. In one embodiment, the tracking system 100 may include medicine 105, tracker 110, scanner 115, computer 120, and wireless signals 122, 124, 126. The tracking system 100 may also include a container 130 including a tracker 132, and a document 135 including a tracker 140.

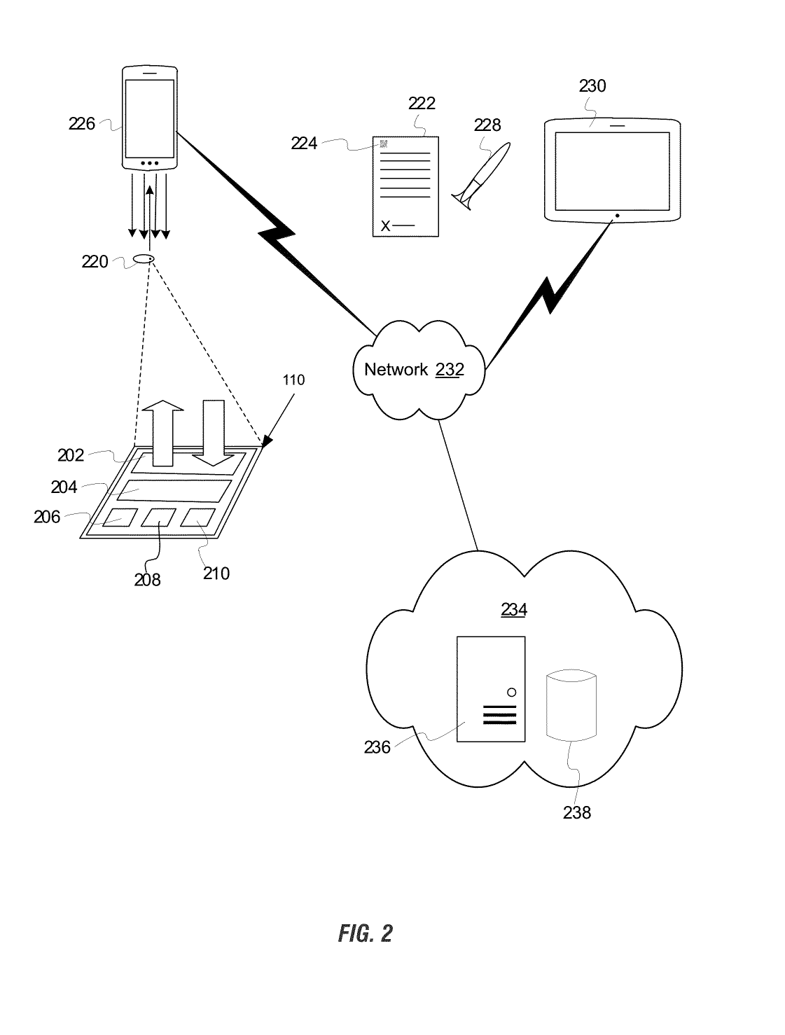

As previously noted, the tracker 110 may be any number of identifying devices or identifiers. In one embodiment, the tracker 110 may be an ultra-small microtransponder tag (e.g., 500×500 microns and 100 microns thick). As shown further shown in FIG. 2, the tracker 110 may include a photocell 202, a memory 204, logic 206, transmitter 208, and an antenna 210 for communicating a radio frequency (RF) signal. The components of the tracker 110 may be interconnected by any number of wires, busses, traces, soldering points, interconnects, or so forth. The tracker 110 may be manufactured utilizing any number of semiconductor manufacturing processes.

In one embodiment, the photocell 202 converts the wireless signal 124 received from the scanner 115 to power for the electronic circuits and components of the tracker 110. In one embodiment, the wireless signal is an optical signal that powers the photocell. The photocell 202 may also capture ambient light (natural or artificial) to power the tracker 110. In one embodiment, the photocell 202 may be activated by a specified frequency, wavelength, or pattern of optical signals, such as a pulsed laser light. For example, a specific frequency may be required to activate and power the tracker 110. In another embodiment, the photocell 202 may be activated by any number of wireless signals (e.g., laser light, wireless signals, light emitting diodes, etc.), radio frequencies, or so forth. The photocell 202 may be covered by one or more protective layers (e.g., colored or translucent materials), such as plastic, glass, resin, glaze, lacquers, or so forth when secured to an item, during manufacturing, or so forth.

The memory 204 stores the identifier associated with the tracker 110. For example, the identifier may be a 30 bit code. Alternatively, the identifier may be larger providing for billions or trillions of unique identifiers. In one embodiment, each tracker may be sequentially or randomly assigned a unique identifier. In another embodiment, the tracker may be assigned the identifier which is then stored in the memory 204. The tracker may be available or may be encoded or encrypted so that the identifier cannot be determined by unauthorized parties. In another embodiment, the memory 204 may also store additional information that is designated for association with the tracker 110.

The tracker 110 may transmit an associated identification responsive to the photocell 202 being activated. In another embodiment, the tracker 110 may also communicate the audio information to the scanner 115 or another communicating device responsive to the tracker 110 being activated to communicate. The tracker 110 may be able to communicate even when integrated or embedded in or coated with translucent materials, such as plastic or glass, or when attached to an item utilizing a semi-transparent adhesive or other material. The photocell 202 may power the memory 204 so that the transmitter 208 may transmit the identifier through the antenna 210. In another embodiment, the antenna 21 may automatically transmit the identifier in response to the tracker 110 being activated by a specific frequency.

The ultra-smile size, low cost of manufacturing, durability, and reliability of the tracker 110 may be extremely useful. In one embodiment, the tracker 110 may be consumed by a user without negative effects on the user. For example, the tracker 110 may be utilized to identify the medication 105 before being consumed. The tracker 110 may be able to endure physical extremes, such as pressure, temperature, chemicals, shocks, and so forth while still functioning. In one embodiment, the tracker 110 is a P-chip® manufactured by PharmaSeq, Inc.

Turning again to FIG. 1, the tracker 110 may be connected to, embedded in, or otherwise integrated with the medicine 105, the container 130, or the document 135. In one embodiment, the trackers 110 and 140 may be utilized to retrieve audio information associated with the individual items once scanned by the scanner 115. The scanner 115 may be a stand-alone device or may be integrated with other devices. For example, the scanner may include a processor, logic, and speaker for communicating information to a user. In another embodiment, the scanner 115 may communicate directly or indirectly with an electronic device, such as the computer 120.

The scanner 115 may represent a wired or wireless device. As shown, the scanner 115 communicates with the computer 120 through the wireless signal 122. Similarly, the scanner 115 receives the wireless signal 126 back from the tracker 110. The scanner 115 may alternatively be connected to the computer 120 by a wire, cable, bus, or other connection. In other embodiments, the scanner 115 or scanner components may be integrated with the computer 120 a wireless device, and e-reader, or other mobile electronic device. The wireless signal 126 may also be received back from the container 130 or the document 135. The information received back by the scanner 115 may vary based on the trackers 110, 140 utilized by the specific item.

Although not shown, the scanner 115 may include a processor, memory, transceiver, memory, bus, microphone, speaker, and other components for performing the operations as are herein described. For example, the scanner 115 may communicate the identifier received from the tracker 110 through the wireless signal 122 to the computer. 120. The computer 120 may include a memory that stores audio information associated with the identifier. In another embodiment, the computer 120 may retrieve the audio information, directly or indirectly, from an external source, such as a server, database, cloud network, or so forth. The identifier may specify an address or access information for a particular site, location, database, or device. As a result, the computer 120 may communicate the audio information to the user in response to the identifier being retrieved from the tracker 110. The computer 120 may simultaneously display relevant information in a number of different formats that may be applicable to the user (e.g., braille, tactile responses, text, projection, etc.).

The audio information that is communicated based on the identifier within the trackers 110, 140 may be general, user specific, or include any number of other details. The audio information may be provided as auditory feedback as mandated by the Food and Drug Administration or other relevant world authorities. In one embodiment, the audio information may be specified by a doctor, pharmacist, or relative of the user and may provide instructions for consuming the medicine 110. For example, the audio information (associated with the medicine 110, the container 130, or both) may instruct the user to take the medicine 110 with food and water at bedtime only. The audio information may include an automatically generated voice or may include a specific user's voice that was prerecorded for utilization when the tracker 110 is read. As a result, the user may feel a sense of comfort from hearing a voice that they recognize or a voice of authority for taking the medication 110. The audio information may include information, flag, or programming for the scanning device to ask about the user's condition after taking the medication to make sure that the user is responding positively. If necessary, an interconnected device may pose additional questions based on the original audio information to determine the status of the user in an ongoing scenario (e.g., preventing unwanted side-effects from affecting the user).

The audio information may include additional instructions or feedback. For example, based on a request, prompt, or question from the user (audible, textual, etc.), the user may be provided with potential side-effects for the medicine 110. The information that is automatically or conditionally communicated to the user based on prompts or requests may be uploaded by a party that associates the audio information with the tracker 110 or the associated identifier. In one embodiment, the audio information is nested for playback to the user in response to certain feedback being received.

The tracker 110 is safe to consume and may even be utilized to determine additional information as it passes through or from the body of the user. In one embodiment, the tracker 110 may include sensors for determining chemical levels (e.g. hormones, chemical composition, etc.).

The audio information may also specific information about the item. For example, the document 135 may be a last will and testament. The audio information may be the recorded voice of the user associated with the well reading the applicable information in the well. As a result, the document 135 may carry an additional level of assurance for surviving heirs that the document is authentic and includes the full intentions of the user. The audio information may then provide a way of authenticating or verifying a document. The user may also specify the intentions and reasoning that were utilized to generate the document 135.

The computer 120 may represent any number of wireless devices, tablets, electronic readers, smart displays, gaming consoles, personal computers, servers, or other intelligent electronic devices. The computer 120 may include one or more displays, speakers, microphones, processors, memories, logic, cards, interfaces, and other components as are known in the art.

The medicine 110, container 130, and document 135 are representative of any number of items that may include the tracker 110. In one embodiment, the tracker 110 may be an integrated portion of a UPC code, QR code, serial number, brand name, logo, or so forth for providing additional information.

FIG. 2 is a pictorial representation of a tracking network in accordance with an illustrative embodiment. The tracking network 200 may also include medicine 220, a document 222, trackers 110, 224, a wireless device 226, a scanning device 228, a tablet 230, network 232, a management network 234, a server 236, and databases 238. The tracking network 200 may provide more embodiments and examples regarding all or portions the tracking system 100 of FIG. 1.

In one embodiment, the wireless device 226 may be configured to activate the tracker 110. For example, the wireless device 226 may include a special transceiver configured to transmit and receive signals that activate the tracker 110 and that are likewise received from the tracker 110. Any number of wireless signals including laser light, special emitting diodes (LEDs), near field communication signals, or so forth, may be utilized.

The wireless device 226 may include built-in functionality for activating the tracker 110. In another embodiment, a separate module, connector, or extension may be integrated with or connected to the wireless device 226 for communication with the tracker 110. The module (not shown) may include a hardware interface for communicating with the wireless device 226 so that the program, applications, or operating system of the wireless device 226 may be utilized to operate the module. The module may be configured to connect to any number of wireless or computing devices.

As shown, the wireless device 226 may read the identifier or information associated with the tracker 110. If the wireless device 226 has associated audio information stored in the internal memory, the wireless device may communicate the audio information to the user. If, however, the wireless device 226 does not have local audio information, the wireless device 226 may retrieve the audio information from a server 236, or a database 238 through one or more networks, such as the network 232 and the management network 234.

The network 232 and management network 234 represent one or more wireless networks (e.g., 4G, 5G, LTE, GSM, WiFi, WiMax, satellite, PCS, wireless mesh networks, CDMA, GPRS, EV-DO,UMTS, and developing standards) or wired networks (e.g., fiber-optic, coaxial, powerline, etc.) utilizing any number of standards or protocols. The network 232 and the management network 234 may represent any number of public, private, or other networks that are operated by one or more communications service providers. The wireless device 226, the scanning device 228, and the tablet, 230 may communicate with the network 232 wirelessly or through any number of wired connections.

In one embodiment, the management network 234 may represent a cloud network including a plurality of servers, databases, and other resources. The management network 234 may control how and when the audio information is communicated to remote devices, such as the wireless device 226, the tablet, 230, and the scanning device 228. In one embodiment, the management network 234 may operate as a publicly available network that stores audio information associated with particular identifiers for ensuring that the associated audio information is communicated once the tracker 210 is scanned. As a result, trackers, such as the tracker 110, may be widely adopted in utilized by various parties with the knowledge that the audio information may be subsequently retrieved once the tracker 110 is activated and the identifier communicated for Association with the audio information.

In one embodiment, the audio information may be available to any party that scanned the tracker 110. In another embodiment, a key, such as a password, encryption key, keyword, token, or other securing information, may be required to originally request the audio information. In another embodiment, the key may be required to decrypt the results communicated from the management network 234 to the applicable device, such as the wireless device 226.

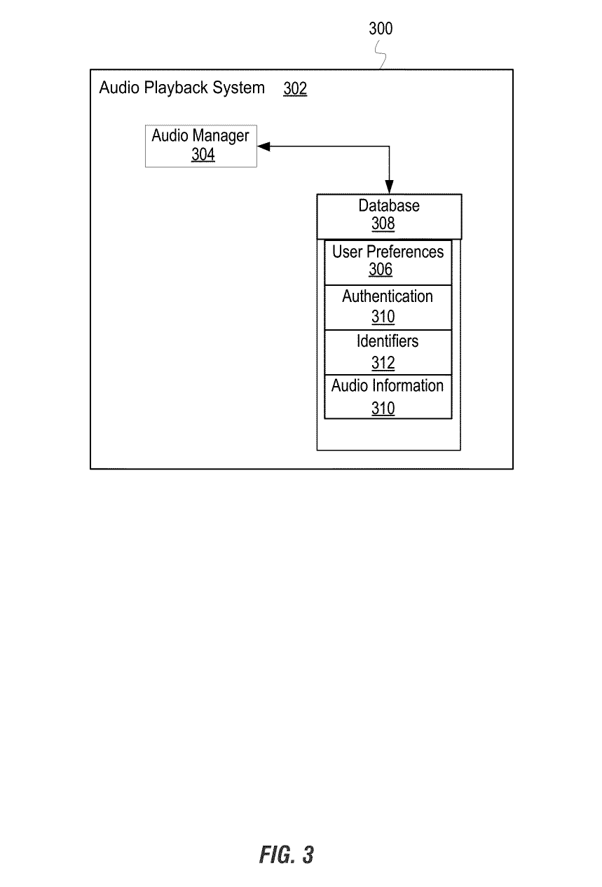

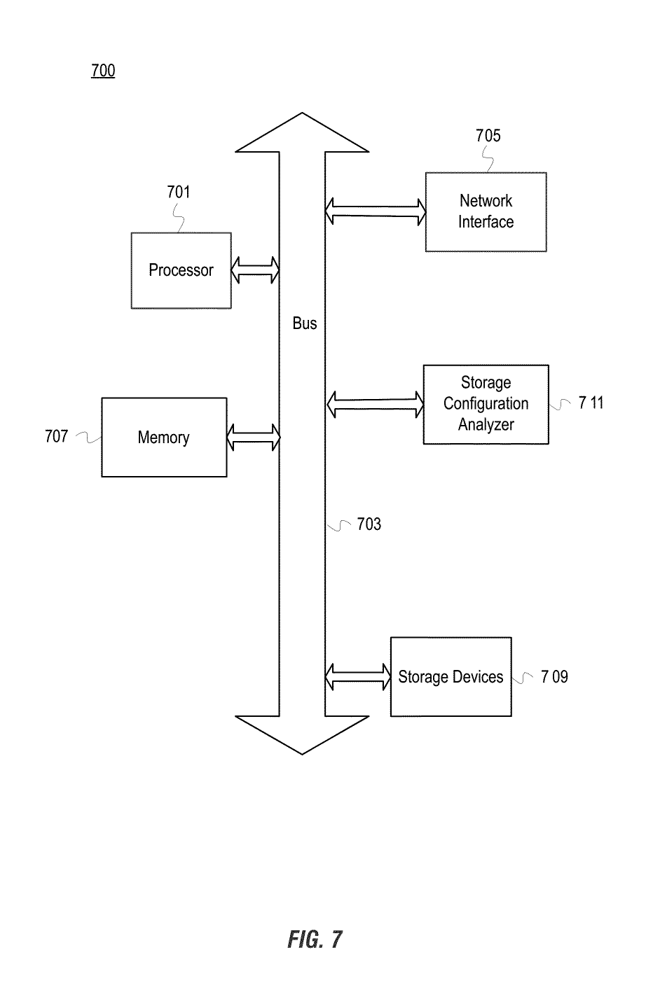

FIG. 3 is a block diagram of a device 300 for performing audio playback in accordance with an illustrative embodiment. In one embodiment, the device 300 may include an audio playback system 302 that is integrated with or executed by the device 300. The device 300 may represent any number of wireless, computing devices, such as the computer system 700 of FIG. 7.

In one embodiment, an operating system, a kernel, or a program (“app”) may be configured to perform the various features, functions, processes, and so forth as are described herein. For example, one or more applications may be executed by the device 300 to implement the features herein described. In one embodiment, all or portions of the audio playback system 302 may be stored, implemented, or executed from one or more memories. In other embodiments, the audio playback system 302 may represent digital logic, one or more field programmable gate arrays, memory architectures, or so forth for implementing the features as are herein described.

In one embodiment, the audio playback system 302 may include an audio manager 304, user preferences 306, a database 308, authentication 310 identifiers 312, and audio information 314. The audio manager 304 may include the logic that may be utilized to associate an identifier with audio information. The logic may include hardware, software, and/or firmware. For example, the audio manager 304 may include transducers, gates, or other hardware logic. The audio manager 304 may also include memory or dynamically configured components for performing the features and processes herein described. The audio manager 304 may be utilized to initially associate an identifier of a tracker, such as a P-chip, with the respective audio information. The audio manager 304 may also be utilized to retrieve the audio information in response to scanning, or otherwise determining the identifier from a tracker.

In one embodiment, the audio manager 304 may communicate with the database 308. The database 308 may store information relative to a tracker including the user preferences 306, authentication 310, the identifiers 312, and the audio information 314. The user preferences 306 may be configured to store any number of settings, criteria, parameters, configurations, or other information utilized by the device 300, the applicable tracker, or the audio playback system 302. In one embodiment, the user preferences 306 may be associated with a particular tracker. For example, the user preferences 306 may specify whether authentication is utilized for reading, communicating, or storing the identifier or the respective audio information, playback preferences (e.g. audio and text display, language, speed, automatic reader, human voice, etc.), and so forth.

The authentication 310 may specify whether or how the tracker, identifier, and/or audio information is authenticated and otherwise safeguarded. The authentication 310 may include a password, certificate-based authentication, context based authentication, or so forth. The identifier itself may be encrypted or otherwise encoded during communication Likewise, the audio information may also be encrypted and may require a key, such as the tracker to be decrypted.

The identifiers 312 stores one or more identifiers associated with a tracker. In one embodiment, a tracker may share a common identifier for identical items or goods. In another embodiment, a tracker may store a number of different identifiers for retrieving distinct information, such as audio information from distinct sources (e.g., financial databases, historical databases, education, etc.).

The audio information 310 stores the audio information for communication to the user. As previously indicated, the audio information 310 may be stored in the device, whether the device represents a local device, such as a cell phone, or a remote device, such as a server.

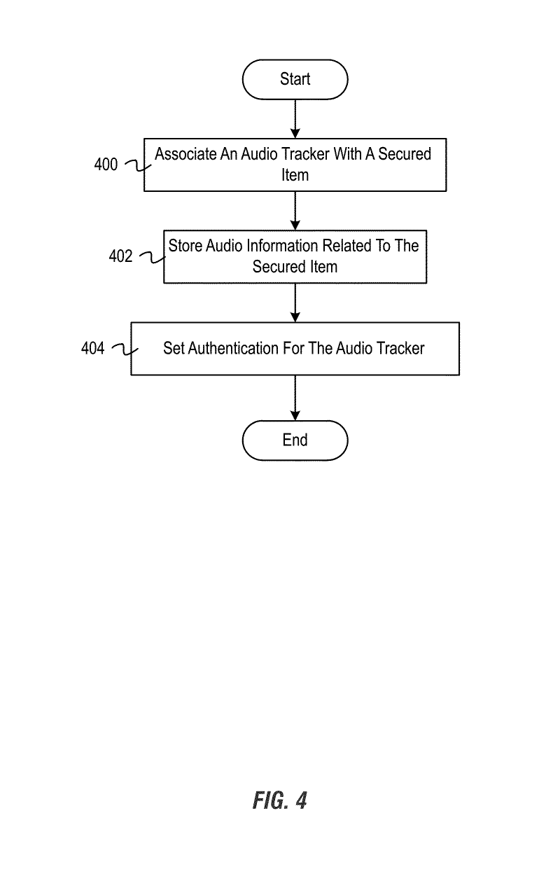

FIG. 4 is flowchart of a process for associating information with an audio tracker in accordance with an illustrative embodiment. In one embodiment, the process of FIG. 4 be implemented by a computing or communications device. The device may be a stand-alone device or may communicate with a network. The device may include one or more microphones for speakers for receiving user input and playing content to the user. In one embodiment, the process may begin by associating an audio tracker with a secured item (step 400). The audio tracker may represent any number of tags, identifiers, or so forth. For example, the audio tracker may be a barcode, microtransponder, or RFID tag. The secured item may similarly represent any number of devices, documents, objects, or so forth. Examples of items may include pills, medicine bottles, documents, books, sample containers, electronics, furniture, collectibles, historical sites, and so forth. In one embodiment, an identifier of the audio tracker may be associated with the secured item (e.g., description, relevant information, etc.). For example, a 30 bit code or alphanumeric reference number or code may be associated with the secured item. In other examples, the identifier may be a serial number, encrypted key, password, barcode, title or description, or so forth.

Next, the device stores information related to the secured item (step 402). In one embodiment, the information may be stored in a database accessible. The database may be publicly or privately accessible. The information may be text or audio information associated with the secured item. In one embodiment, the information may be text indicating the type of material, date, and instructions associated with Internet item. In another embodiment, the information will be instructions for utilizing the secured item details about the secured items religion. In one embodiment, the information may be stored within the memory of the audio tracker. A duplicate copy of the information may also be stored online for access by one or more users. Embodiment, the information may be associated with the secured item utilizing the one or more identifiers associated with the audio tracker.

Next, the device sets authentication for the audio tracker (404). The user configuring the audio tracker may be able to set authentication for the audio tracker or may leave the authentication open. For example, the user may be able to establish that no authentication information or security information is utilized with the audio tracker. In another embodiment, the authentication may require one or more passwords, identifying phrases, keywords, encryption keys, or so forth that may be provided (e.g., text, voice command, password, pin, biometric, optical code, wireless signal, etc.). In one embodiment, the authentication may be encrypted to ensure that it is not easily broken or hat.

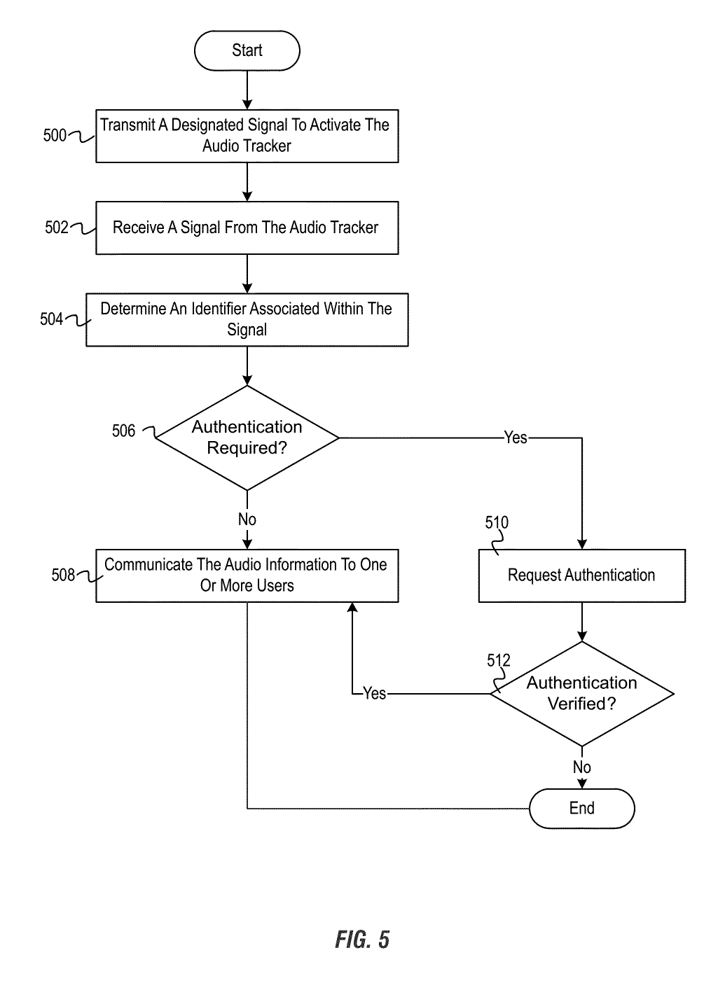

FIG. 5 is a flowchart of a process for playing audio information associated with an audio tracker in accordance with an illustrative embodiment. The process of FIG. 5 may also be implemented by an electronic device or audio system as herein described.

The process of FIG. 5 may begin by transmitting a designated signal to activate the audio tracker (step 500). In one embodiment, the designated signal is an optical signal (e.g., laser light pattern). In another embodiment, the designated signal may represent a particular frequency, channel, data signal, or so forth that may activate the audio tracker. For example, a particular signal may be utilized to activate a chip or RFID tag of a secured item. In another embodiment, the designated symbols signal may represent an image capture system utilized to retrieve an optical signal associated with the secured item. For example, the optical signal may be an image, reflected light pattern, or so forth.

Next, the device receives a signal from the audio tracker (step 502). The signal may represent an automatically generated communication from the audio tracker back to the device. In one embodiment, the audio tracker is a passive device that is activated by the designated symbol signal to temporarily transmit information back to the device. In another embodiment, the audio tracker may be an active device including a power supply and transceiver for sending the signal to the device.

Next, the device determines an identifier associated with the signal (step 504). The identifier may have been previously associated with the audio tracker. For example, the audio tracker may include a unique identifier that is assigned at the time of creation of the audio track. In another embodiment, the identifier of the audio tracker may be assigned by a system, user, or other component.

Next, the device determines whether authentication is required (step 506). The determination of step 506 may be determined based on whether authenticating information or data is required. For example, one or more fields, attributes, passwords, identifiers, or authenticators may be associated with the identifier and or the audio tracker. As a result, the user may be required to provide authentication information before accessing the information stored by the audio tracker.

If no authentication is required during step 506, the device communicates the information to one or more users (step 508). During step 508, the information may be communicated, displayed, played, or otherwise presented to the one or more users. In one embodiment, the information may represent audio content that was prerecorded for playback in response to the identifier being provided. For example, the information may be converted to an audio format for playback to the one or more users. The information may also be displayed in text on the device for the users. The information may also be streamed to any number of nearby devices configured to receive a communication from the audio tracker regarding the secured item. After communicating the information to the one or more users during step 508, the process ends.

If the device determines that authentication is required in step 506, the device request authentication (step 510). Authentication may be performed in any number of ways. In one embodiment, the authentication performed between the device and the audio tracker for retrieving the information. In another embodiment, the information is authenticated by providing an identifier through one or more networks to a secure location where the identifier is associated with the information. In any of the embodiments, the user may be required to provide an identifying biometric, password, or other identifier to receive the information or to decode the information that is received from the audio tracker. For example, the device may request an encryption key for opening the information stored within the audio tracker.

Next, the device determines whether authentication is verified (step 512). If the authentication is not verified, the process ends. The process ends because the device or associated user is not authorized to access the information stored by the audio tracker. In one embodiment, the device may the restart the process of FIG. 5 to try a distinct identifier for authenticating the user and/or device. If the authentication is verified during step 512, the device 508 communications the audio information to one or more users (step 508) before ending the process.

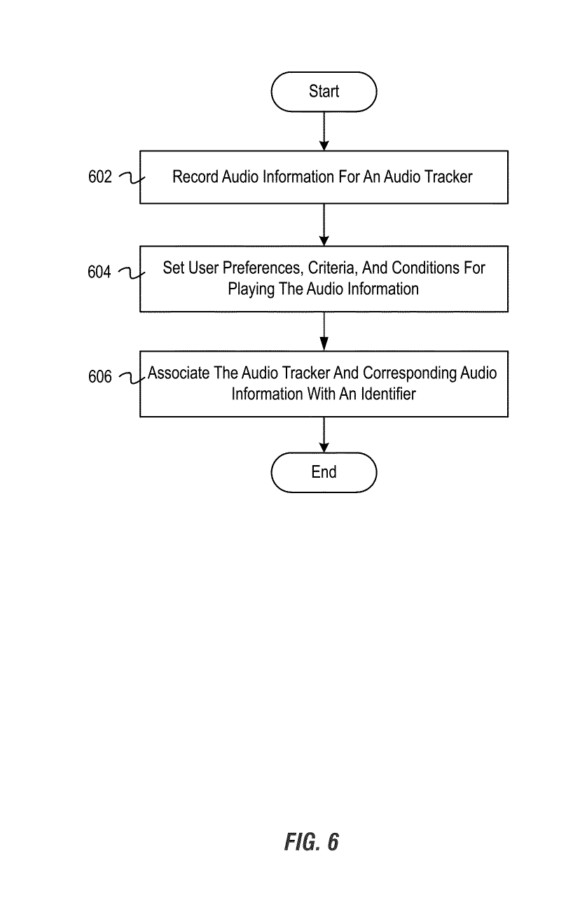

Turning now to the flowchart of FIG. 6, the process of FIG. 6 may be implemented utilizing an audio tracker system as is herein described. The process may begin by recording audio information for an audio tracker (step 602). The audio information may be recorded utilizing an electronic device, such as a cell phone, laptop, tablet, wireless device, professional recording equipment, wearable computing device, or so forth. The audio information may be information that is associated with the audio tracker and/or an item to which the audio tracker is attached or paired. The audio information may be instructions, general information, or so forth. The audio information may include a specific audio file, text, images, video, or other files or information. The audio information may include a link to a cloud network, web server, database, or other access point that may store or archive information for subsequent retrieval.

In another embodiment, the audio information may be an audio conversion of text comment that is performed automatically. For example, a text-to-voice conversion may be automatically performed for the relevant information. The user may be able to set the gender, speed, accent, language, and so forth for the audio information.

Next, the systems sets user preferences, criteria, and conditions for playing the audio information (step 604). The user preferences, criteria, factors, and conditions may be set based on user input. The user preferences and conditions may specify when and how the audio information is played, broadcast, displayed, or otherwise communicated to one or more users based on a request (e.g., a request including the identifier of the audio tracker). The conditions may specify what factors must be met to communicate the audio information.

Next, the system associates the audio tracker and corresponding audio information with an identifier (step 606). The identifier may be random or assigned by a user. For example, the identifier may be 30 bit identification code that is randomly assigned during the manufacturing process of the audio tracker (e.g., microtransponder).

In addition, the audio tracker may be connected, attached, bonded, sealed, or otherwise integrated with an item. For example, the item may be a container, medication, collectible, or other item as is herein disclosed. The audio tracker may be connected utilizing a gun, adhesive, plastic, sealant, glass, manufacturing process, or so forth.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

FIG. 7 depicts an example computer system 700. A computer system 700 includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 may include one or more functionalities that facilitate retrieval of the audio information associated with an identifier. Code may be implemented in any of the other devices of the computer system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

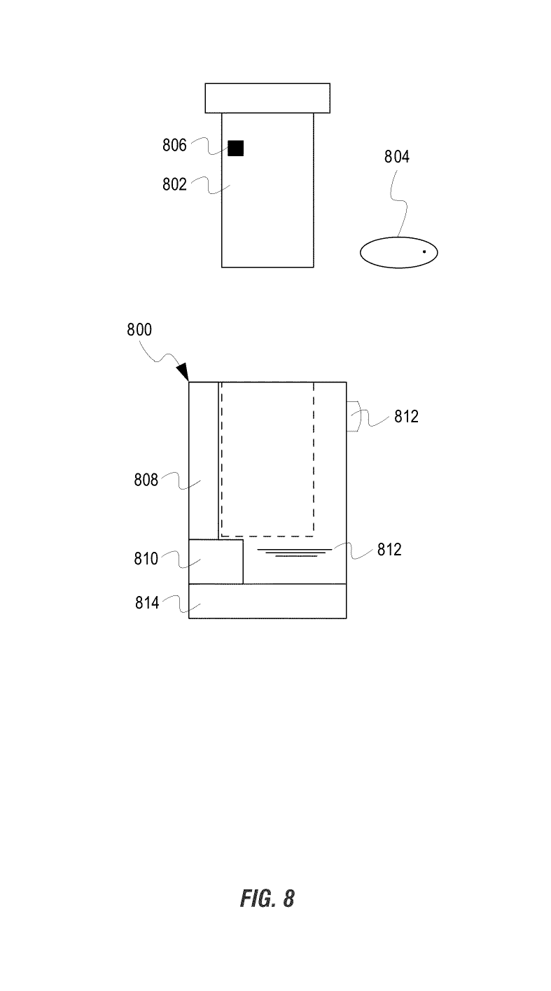

FIG. 8 is a pictorial representation of an audio bottle holder 800 in accordance with an illustrative embodiment. In one embodiment, the audio bottle holder 800 may be configured to receive the container 802 that stores the medicine 804. As previously disclosed, the container 802 may include an identifier 806, such as a QR code, a serial number, a barcode, an RFID chip, a near field communications device, or so forth.

The audio bottle holder 800 defines a receptacle for receiving all or a portion of the container 802. In another embodiment, the audio bottle holder 800 may be attached to the container 802 on an exterior surface of the container 802. The audio bottle holder 800 may be attached utilizing straps, Velcro, a ratcheting or tightening band, suction, mild adhesives, clamps, or so forth. In yet another embodiment, the audio bottle holder 800 may function as a replacement top for the container 802. For example, the audio bottle holder 800 may act as a smart lid for the container 802.

The audio bottle holder 800 may include a reader 808 for reading the identifier 806. For example, the reader 808 may optically scan a serial number, barcode, QR code, P-chip, or other optical identifier associated with the container 802. The user may place the container 802 within the audio bottle holder 800 and then rotate or move the container 802 until the reader 808 is able to read the applicable identifier 806, or other relevant information printed on a label of the container 802 or otherwise attached to or integrated with the container 802. The reader 808 may also include a scanner for performing optical character recognition of the information printed on the container 802 or a label of the container 802. For example, by rotating the container 802 within the audio bottle holder 800, the reader 808 may read and identify all of the applicable information (e.g., utilizing optical character recognition). In another embodiment, the reader 808 may include a transceiver for communicating with an RFID tag or near field communication chip attached to the container 802. The relevant identifier or information may be determined through the transceiver.

The reader 808 communicates with the logic 810, a speaker 812, and a battery 814. For example, the logical components of the audio bottle holder 800 may communicate through any number of wires, buses, or interconnects. The battery 814 may power the components of the audio bottle holder 800. The battery 814 may be reusable or may alternatively be disposable. In another embodiment, the battery 814 may include an inductive charger for charging the audio bottle holder. The audio bottle holder 800 may also include a power cord so that the audio bottle holder 800 may be powered from a wall outlet or other wired source of power.

The logic 810 controls the functionality of the audio bottle holder 800 including delivery of the audio information to the user. In one embodiment, the reader 808 may determine the name of the prescribed user, address, name and dosage of the medication, why the medication is being taken, instructions for consuming the medication, quantity, refills, prescriber, date filled, discard date, medication description, side effects, dosage information, and so forth. In one embodiment, the logic 810 may be able to communicate any of the available information, or selectively deliver the most relevant information, such as type of medication, consumption instructions, alerts, and so forth.

The logic 810 may also be configured to deliver alerts to the user. For example, an audible, visual, and/or verbal alert may be played to the user when it is time to take the medication. The logic 810 may also communicate an alert to an outside party if the medication is not taken within a designated time period. In one embodiment, the logic 810 may include a counter (e.g., optical, mechanical, etc.) for determining whether any medication has been taken. In addition, the logic 810 may prompt the user to provide a status to determine if the medication is working effectively. For example, the audio bottle holder 800 may ask the user “Have you taken your medicine?” If the response is affirmative, the audio bottle holder 800 may ask “Are you feeling better or worse?” Alternatively, the audio bottle holder 800 may ask an open-ended question, such as “How are you feeling now?” The answer may be recorded by the audio bottle holder 800 and stored and/or communicated to specified parties and/or communicated to other devices or applications. In some instances it may be advantageous to collect information regarding the taking of medication from the audio bottle holder 800 as this encourages compliance by the user and may be more accurate information than the user might otherwise voluntarily provide which incorrect indicating compliance with a prescription medication schedule.

It is contemplated that the audio bottle holder 800 may be used to communicate with more than the bottle being held by the audio bottle holder 800. The audio bottle holder may communicate with other nearby trackers such as those associated with other medicine containers, medications, or otherwise.

Once information is collected from the audio bottle holder, this information may be used for any number of purposes. Information may include tracking usage of the medication including the date and time the medication was taken, the dosage taken, the individual taking the medication, and other information. Usage information may be used to determine compliance with prescription instructions, identify potential issues with drug interactions between different medications, determine when prescription refills or prescription renewals are needed, or for other purposes.

The functionality associated with the audio bottle holder and the use of trackers may be used in various ways.

In one embodiment, the logic 810 may include an interface 816 for allowing the user to select to receive information. For example, the interface may include one or more pushbuttons, dials, soft buttons, or other selection components that when selected by the user communicates the applicable information associated with the container 802/medication 804 to the user. The user may also select to replay information or play distinct information. The interface 816 may also include a touch sensor, proximity sensor, or accelerometer that activates the audio bottle holder 800 in response to touch, proximity, movement, or so forth. The interface 816 may also provide a Braille interface for users that have sight disabilities.

The logic 810 may also include a transceiver for communicating with any number of external devices or components, such as routers, wireless devices, computers, servers, networks, or so forth. For example, the transceiver may include a Bluetooth interface for playing alerts or audio information to the user through a louder or more capable speaker. In one embodiment, the transceiver may be configured for Bluetooth, WiFi, cellular, Zigbee, NFC, or other forms of communication. Thus, the bottle holder may be able to communicate with other computing devices such as computers, tablets, mobile phones, other mobile devices, wearable devices, and other types of intelligent electronic devices. These communications can take various forms and include various types of information. Thus, information from the bottle holder including usage information or other information collected from the user may be communicated to health monitoring computer applications, health monitoring mobile apps, or otherwise.

Where the bottle holder communicates with other devices, it is contemplated that the bottle holder may interact with the user in part through the other devices. Thus, for example, messages from the bottle holder may be displayed on another device (e.g. the display of an intelligent electronic device such as a mobile phone), audio may be output through the other device (e.g. a speaker associated with an intelligent electronic device), and user input may be received through the other device(s).

Where the bottle holder communicates with other devices, it is further contemplated that the presence of the other device may be used in order to assist in identifying the user. For example where the other device is a wearable device such as a watch, band, glasses, or jewelry worn by a user, the identity of the individual may be inferred. The strength of the inference may vary based on the other device, its type, or other available information.

It is to be further understood that when used for communicating medication related information, identifying the tracker (such as through reading, scanning, or otherwise inputting tracker information) may be used in determining the occurrence of a medication event. Then in response to the medication event, the audio information may be played and/or other actions may be taken. For example, the medication event may be associated with placing a bottle of medication in the bottle holder, or bringing an intelligent electronic device in close proximity to the bottle, or other event.

It is further contemplated that the medication event may be based on a combination of inputs in addition to the tracker information. Additional information may be combined with the tracker information to provide context in order to establish that a medication event has occurred or not occurred. For example, information regarding when the tracker information is obtained may be used, information regarding the identity of devices associated with the user, or other information either sensed or determined by the bottle holder or devices in communication with the bottle holder, including information determined from user input.

Upon occurrence of the medication event, the audio information may then be played. The audio information may include dosage information, information regarding the name or type of medication, information relevant to avoiding adverse drug interactions, information regarding when to stop taking the medication, information regarding avoiding other activities when taking the medication such as the need to avoid driving or operating heavy equipment, or drinking alcohol. The audio information may also include reminders regarding when the next dosage should be taken.

Thus, it should be understood that with an item, the tracker information may be used to store audio information which may include multiple audio messages and the bottle holder or a device in communication with the bottle holder may provide additional information to be used in determining when a particular audio message is appropriate to be played. In another embodiment, the audio bottle holder 800 may include one or more displays (not shown) for displaying video, text, alphanumeric characters, or so forth to the user as part of the information delivered by the audio bottle holder. The display may provide large font to replace the potentially small labels of the container 802. In another embodiment, the display may be

In one embodiment, the speaker 812 may be configured to audibly play the information relevant to the container 802 and the corresponding medicine 804. The speaker 812 may include a volume control to ensure that the user is able to hear the relevant information.

In another embodiment, the audio bottle holder 800 may function as a container itself for storing medicine. The medicine may be stored in the audio bottle holder 800. A lid or top may be utilized to seal the medicine for freshness.

In another embodiment, the audio bottle holder 800 may be include a digital voice recorder (not shown) for recording instructions from a doctor, pharmacist, family member or friend, or other party associated with the user. For example, instructions may be recorded by a pharmacist at the time the medication is allocated and distributed at the pharmacy. In another example, the instructions may be recorded by a doctor or family friend that is with the doctor at a doctor's office and for use by a user. In one embodiment, a company that distributes legal medication may have an exchange program whereby the audio bottle holder 800 is individually configured with audio information that includes consumption instructions, side effects, contact information, and so forth for a specified user.

In another embodiment, a responsible person, such as caregiver, family member, or friend may program the audible bottle holder 800 for a specific medication that the user takes. As a result, instructions for taking the medication within the container 802 temporarily stored in the audio bottle holder 800 to facilitate the user in taking the medication. Once the medicine within the audio bottle holder 800 is consumed, the audio bottle holder 800 may be returned to be reprogrammed and utilized again (recycled). As previously disclosed, the digital voice recorder may also record feedback from the user.

While the embodiments are described with reference to various implementations and exploitations, it will be understood that these embodiments are illustrative and that the scope of the inventive subject matter is not limited to them. In general, techniques for tracking items and communicating audio information associated with the audio trackers as described herein may be implemented with devices, facilities, or equipment consistent with any hardware system(s). Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for storing audio information comprising:
generating audio information for association with a tracker of an item;
determining an identifier associated with a tracker;
associating the audio information with the identifier; and
storing the audio information in a database for subsequent retrieval utilizing the identifier.

2. The method of claim 1, wherein the audio information is a recording of a user for association with the item.

3. The method of claim 1, wherein the audio information is a text to voice conversion of information associated with the item.

4. The method of claim 1, further comprising:
assigning the identifier to the tracker.

5. The method of claim 1, wherein the identifier is a serial number, and wherein the tracker is a microtransducer.

6. The method of claim 1, wherein the database is publicly accessible to a plurality of users, wherein the database stores separate distinct information for a plurality of identifiers including the information and the identifier.

7. The method of claim 1, wherein the identifier and information is encrypted.

8. The method of claim 1, communicating the audio information to a user at least audibly.

9. The method of claim 1, wherein the audio information includes criteria for subsequent communication to a user.

10. A system for storing audio information comprising:
a scanner configured to determine an identifier associated with a tracker;
an interface configured to receive audio information associated with the identifier; and
a database for storing the audio information associated with the identifier for subsequent retrieval.

11. The system of claim 10, wherein the system is a wireless device with an integrated scanner for determining the identifier from the tracker utilizing an optical signal.

12. The system of claim 10, wherein the interface records audio input from a user to associate with the tracker that is connected to an item.

13. The system of claim 10, wherein the database is publicly accessible to a plurality of users, wherein the database stores separate distinct information for a plurality of identifiers including the information and the identifier.

14. The system of claim 10, wherein the tracker is a microtransponder activated by an optical signal.

15. The system of claim 10, wherein the database stores a plurality of identifiers associated with a plurality of audio information.

16. A non-transitory machine-readable storage medium having instructions stored therein, which when executed by a processor causes the processor to perform operations that comprise:
generating audio information for association with a tracker of an item;
determining an identifier associated with a tracker;
associating the audio information with the identifier; and
storing the audio information in a database for subsequent retrieval utilizing the identifier.

17. The non-transitory medium of claim 15, wherein the audio information is one of a recording of a user for association with the item and text to voice conversion of information associated with the item.

18. The non-transitory medium of claim 15, wherein the tracker is a microtransponder that is optically activated to generate a signal including the identifier.

19. The non-transitory medium of claim 15, further comprising:
assigning the identifier to the tracker.

20. The non-transitory medium of claim 15, wherein the database is publicly accessible to a plurality of users, wherein the database stores separate distinct information for a plurality of identifiers including the information and the identifier.

21. The non-transitory medium of claim 15, wherein the identifier requires authentication by a user to communicate the audio information.
